(19) United States
(12) Patent Application Publication
(10) Pub. No.: US 2010/0066105 A1
(43) Pub. Date: Mar. 18, 2010

(54) Locking Device

(75) Inventor: Stephane Perche, Saint Bardoux (FR)

Correspondence Address: OLIFF & BERRIDGE, PLC, P.O. BOX 320850, ALEXANDRIA, VA, 22320-4850, US

(73) Assignee: Exsto, Romans Sur Isere (FR)

(21) Appl. No.: 12/085,358

(22) PCT Filed: Nov. 27, 2006
(86) PCT No.: PCT/FR2006/002589

§ 371 Date: Jul. 31, 2008

(30) Foreign Application Priority Data
Nov. 30, 2005 (FR) 0512114

(51) Int. Cl. E05C 17/46

(52) U.S. Cl. 292/262

(57) ABSTRACT

The present invention relates, on the one hand, to a device (1) for locking an opening element (3) with respect to a fixed element (23) of a motor vehicle body, characterized in that it is intended to be fixed on a wall (3a) of the opening element or of the fixed element, and in that it comprises at least one stop means (5) designed to cooperate elastically with at least one complementary stop means (31), attached to the fixed element or to the opening element respectively, so as to allow the retention of said opening element, and relates, on the other hand, to a corresponding spacing device.

The present invention relates to a device for locking an opening element on a fixed element of a motor vehicle body as well as a corresponding spacing device.

Before permanent attachment of an opening element, such as a door, a hood or a tailgate, among others, on a fixed element of a motor vehicle body, one generally carries out steps for applying one or several coatings, such as protective coatings or the application of a layer of paint. During such treatments, these opening elements are not yet equipped with permanent closing devices, such as locks.

For this reason, temporary spacing devices are provided which make it possible to maintain an opening element in a pseudo-closed position in relation to the fixed element to which it must be attached.

Depending on the configuration of the vehicle body and the opening element, said opening element may adopt a naturally closed or naturally open position, i.e. under the effect of its weight, the opening element naturally tends to open itself. In such a case, it is appropriate to give the temporary spacing device a locking function making it possible to keep the opening element in the desired pseudo-closed position.

Documents FR 2 833 562 and EP 0 931 895 each describe a device of this type comprising, on one hand, a fixing plate designed to enable anchoring of the device in the fixed element, and on the other hand a body attached to the fixing plate and forming a stop element able to serve as a support for the opening element.

In a device according to document FR 2 833 562, the fixing plate is immobilized in the vehicle body, with the help of a peg designed to penetrate an orifice of the vehicle body and a screw designed to go through an orifice of the fixing plate to be fixed in a tapped orifice of the vehicle body.

In a device according to document EP 0 931 895, anchoring of the fixing plate is done via at least one tapped orifice arranged in the vehicle body and each designed to receive a peg integral with the fixing plate. A peg of this type is provided with peripheral fins able to cooperate with the corresponding tapped orifice when an operator exerts pressure on the temporary spacing device. A screw may be used as complementary fixing means. The advantage of this type of fixing is that it does not require any tools during assembly of the maintenance device. However, when the stresses to be borne are too great, one may add a screw, which does require a tool for its insertion.

For each of the spacing and locking devices described in documents FR 2 833 562 and EP 0 931 895, the locking function is provided by an elastic retaining pin. This retaining member is formed by an elastic tab extending above the body and tilted in the direction opposite the stop element. This elastic tab is designed so as to be able to cooperate with a rim of the opening element. During closing of the opening element, this exerts a thrust able to cause the elastic tab to bend such that the rim passes behind said tab. The tab then resumes its initial position and ensures blocking of the rim and, as a result, of the opening element.

However, this type of locking system has drawbacks related to the direct contact between the rim and the tab. Indeed, during locking, there is a plastic/metal contact between the tab and the rim of the opening element. The rim being thin and sharp, this contact leads to the formation of plastic shavings which then fall on areas to be painted and lead to flaws in the painting.

The present invention aims to resolve the drawback stated above, and to this end consists of a device for locking an opening element on a fixed element of a motor vehicle body, characterized in that it is designed to be fixed on a wall of the opening element or of the fixed element, and in that it comprises at least one stop means able to cooperate elastically with at least one complementary stop means, connected to the fixed element or to the opening element, respectively, so as to enable retention of said opening element.

“Opening element” refers to any part of the vehicle body, such as a door, which is mobile in relation to the body of the motor vehicle body and whereof the weight and structure are such that there is a natural tendency toward opening during assembly operations.

Thus, providing a device dedicated to the locking function makes it possible to avoid direct contact between the wall of the opening element and the locking element, the opening element no longer grating against the locking element. The contact between the stop means of the locking device and the complementary stop means is therefore particularly advantageous insofar as it makes it possible to avoid the formation of shavings.

Preferably, the locking device is designed to be fixed in a wall of the opening element. Advantageously, the locking device is designed to be fixed at the level of a door lining. However, it must be clearly understood that in variation, the locking device can be fixed in a wall of the fixed element.

In a locking device according to the invention, the stop means can be chosen able to undergo elastic deformation under the action of the corresponding complementary stop means. In variation, the stop means may be chosen to be stiff and able to elastically deform the complementary stop means.

According to a first preferred embodiment of the invention, the stop means is made in the form of at least one protruding retaining member.

According to a second preferred embodiment of the invention, the stop means is able to cooperate with a complementary stop means via a swivel.

Preferably, the locking device has clipping fixing means.

The present invention also relates to a device for temporary spacing of an opening element on a fixed element of a motor vehicle body, comprising, on one hand, fixing means, and on the other hand, at least one stop element able to serve as a bearing support for the opening element, characterized in that it comprises at least one stop means able to cooperate with the corresponding stop means of a locking device according to the invention.

Advantageously, the stop means is in the form of a protruding retaining finger.

Also advantageously, the stop element is designed so as to be able to be housed between the fixed element and the opening element. In this way, the stop element comes into contact with the opening element via an area not visible and therefore does not create any painting flaws.

The implementation of the device will be better understood with the help of the detailed description below with regard to the appended drawing, in which:

FIG. 1 is a longitudinal diagrammatic side view of a first embodiment of a locking device according to the invention placed between a door and a vehicle body and able to cooperate with a complementary spacing device.

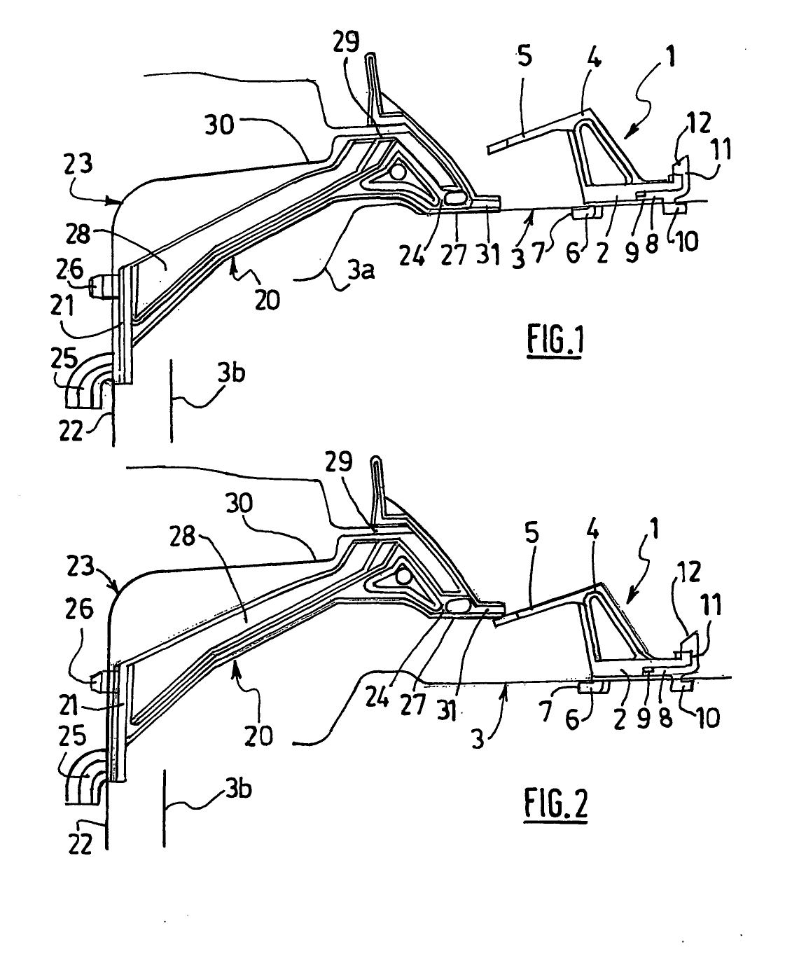

FIG. 2 is an illustration of the locking device of FIG. 1 during closing.

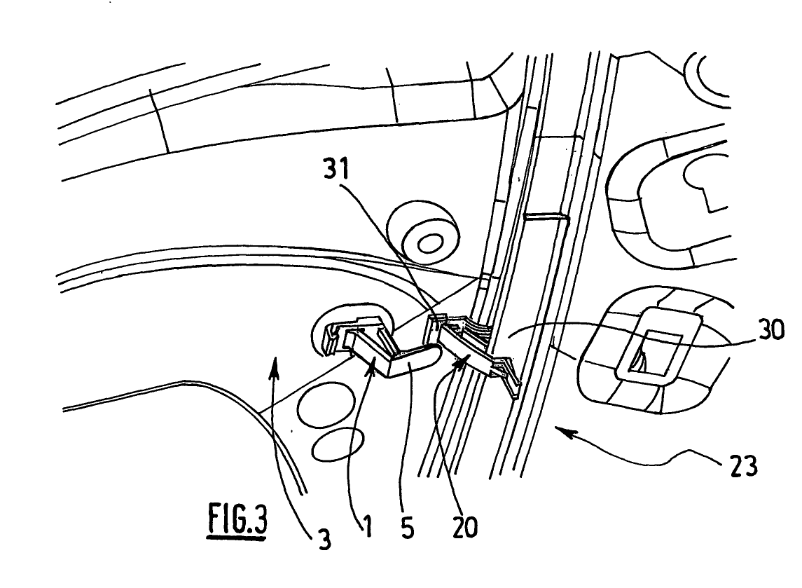

FIG. 3 is an overall perspective view of the locking device of FIG. 1.

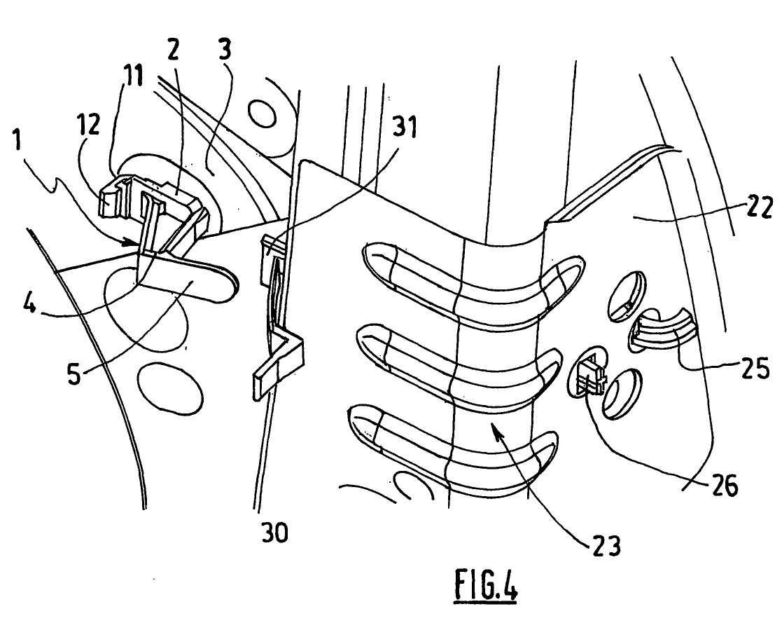

FIG. 4 is a bottom perspective view of the locking device of FIG. 1.

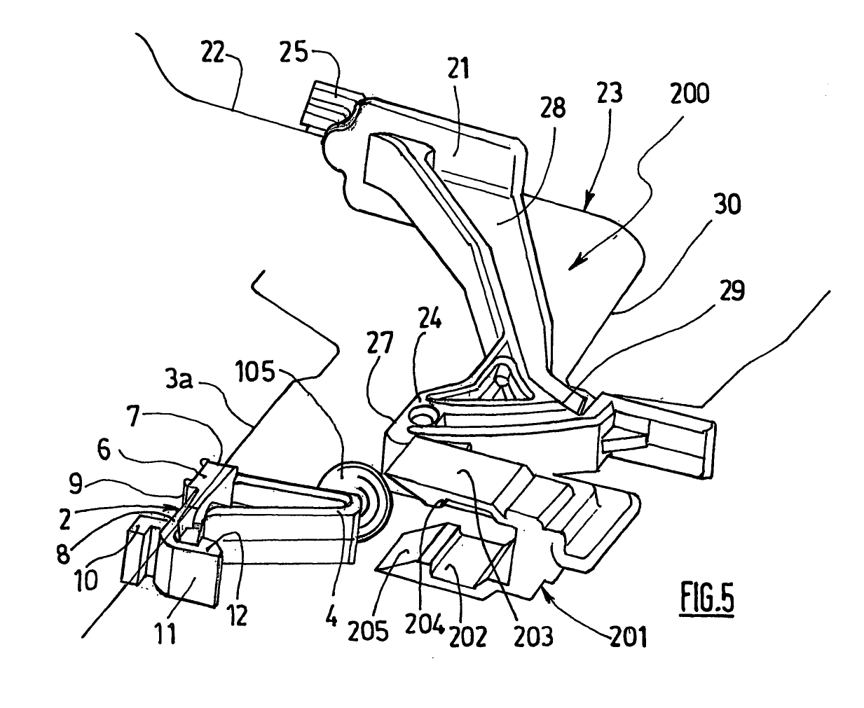

FIG. 5 is a diagrammatic perspective view of a second embodiment of a device according to the invention placed between a door and a vehicle body and able to cooperate with a complementary spacing device.

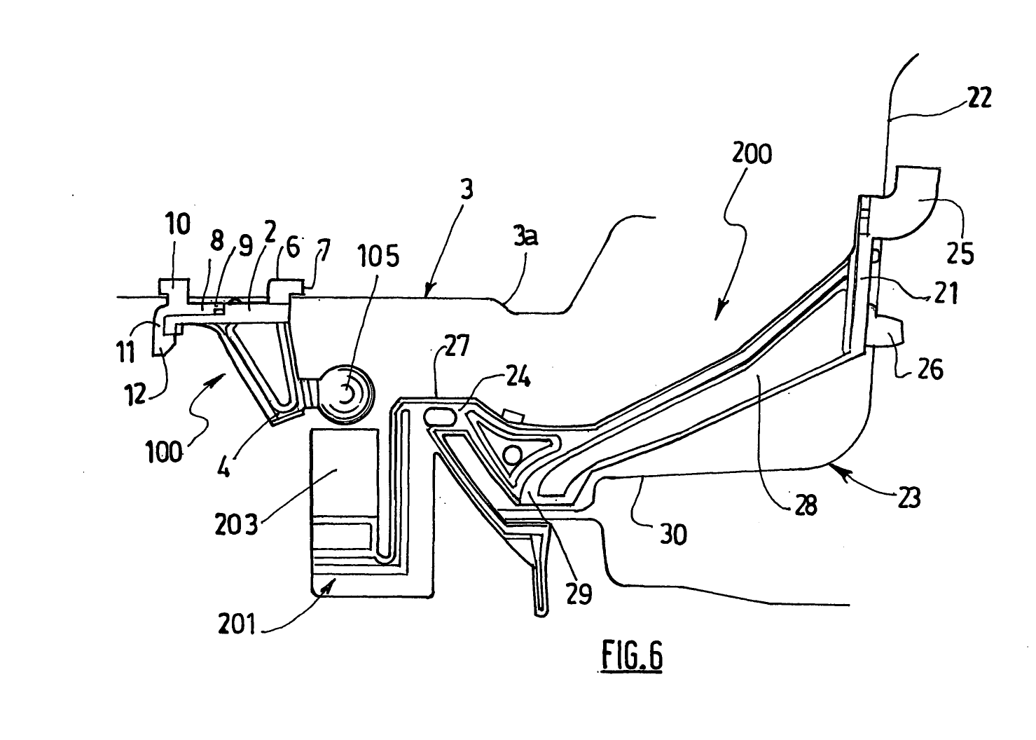

FIG. 6 is a longitudinal diagrammatic side illustration of the locking device and the related spacing device as shown in FIG. 5.

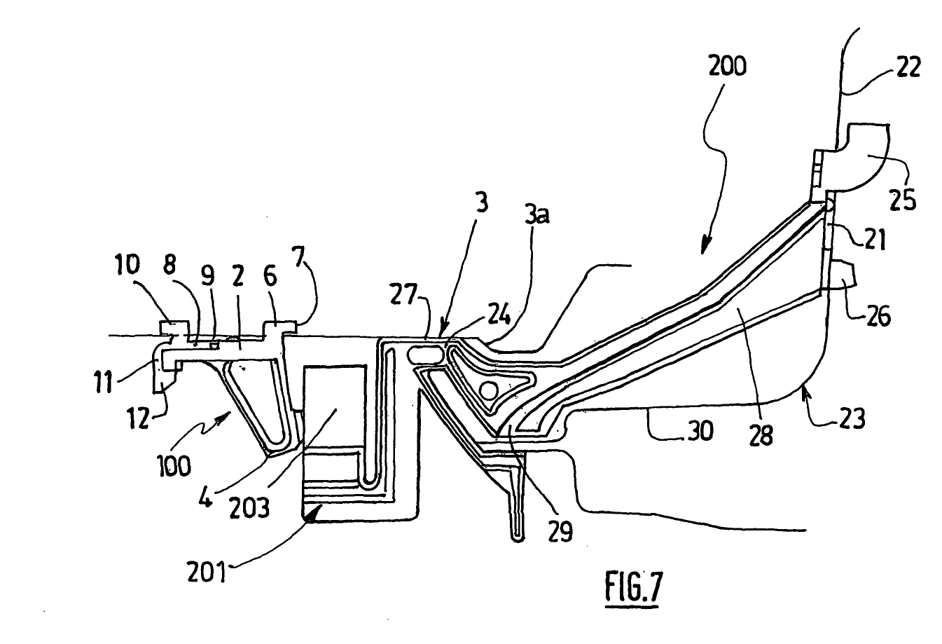

FIG. 7 is a longitudinal diagrammatic side view of the locking device and the associated spacing device as shown in FIG. 6 before closing.

In the following description, the same elements for the various embodiments bear the same references.

According to a first embodiment shown in FIGS. 1 to 4, a locking device 1 according to the invention comprises a body made from a thermoplastic material molded in a single piece, said body being made up on one hand of a fixing plate 2 designed to enable temporary anchoring of the locking device 1 in an opening element 3 such as a door of a motor vehicle body, and on the other hand, a head 4 extending perpendicularly from the fixing plate and terminated by an elastic retaining member 5 extending along the plane of the opening element 3 from the head 4.

The fixing plate 2 is equipped with attachment means comprising, on one hand, a first fixing member located on the side of the elastic retaining member 5 and forming a lip 6 turned toward the outside of the fixing plate 2, and on the other hand, a second fixing member 8 mounted pivoting around a transverse axis of the fixing plate 2. To do this, the second fixing member 8 is connected to the fixing plate via a flexible tab 9 made in the shape of a thin veil of thermoplastic material. It is, of course, possible to produce a locking device 1 in two pieces, the second fixing member 8 then being mounted on an axis fixed parallel to the fixing plate 2. This second fixing member 8 is equipped with a lip 10, turned toward the outside of the fixing plate in a direction opposite the lip 6, and has one end 11 curved toward the fixing plate provided with locking hooks 12 able to engage with the fixing plate 2 on both sides of the head 4. Of course, other fixing means can be used, such as screws or clipping fixing means.

This locking device 1 is designed to cooperate with a complementary temporary spacing device 20, as shown in FIGS. 1 to 3, comprising a single-piece body designed from a shaped thermoplastic material, being made up, on one hand, of a fixing plate 21 designed to enable temporary anchoring of the spacing device in a wall 22 of a fixed element 23 of a motor vehicle body, and on the other hand, of a stop element 24 designed to serve as a bearing support for the door 3.

The fixing plate 21 is equipped with attachment means comprising, on one hand, a retaining member 25 having a bent end forming a lip, and on the other hand, a positioning finger 26, each designed to be inserted into a corresponding orifice of the wall of the fixed element 23. This therefore involves a screw-free fixing system by interlocking of the fixing plate 21. Alternatively, one can provide for a fixing system using screws or clipping.

The stop element 24 is made in the form of a stiff protuberance having a contact surface 27 designed to come into contact with a wall of the door 3 and is attached to the fixing plate 21 by an intermediate part 28 which is generally in the shape of a scorpion tail.

More precisely, the intermediate part 28 and the stop element 24 are formed so as to create a space able to receive a rim 3a of the opening element 3, the stop element thus being able to come into contact with the door 3 on an area thereof which is not visible.

Moreover, the temporary spacing device 20 comprises a second fixing point 29 located away from the fixing plate and designed to engage with a second wall 30 of the fixed element substantially perpendicular to the wall 22 and commonly called a rabbet.

The temporary spacing device 20 is terminated by a finger 31 located facing the locking device 1 and extending in a direction substantially parallel to the plane of the opening element 3 when this element is in the closed position so as to be able to cooperate with the elastic retaining member 5 of the locking device 1 and serving as stop means for it. More precisely, the finger 31 of the spacing device 20 cuts the path of the elastic retaining member 5 during opening or closing of the door 3.

A user wishing to lock a door 3 in a spacing position close to its closed position in relation to a fixed element 23 of a motor vehicle body using a spacing device 20 and a locking device 1 according to the invention, will proceed as follows.

Initially, the fixed element 23 of the vehicle body is placed on an assembly chain along which it progresses in order to undergo various assembly operations. This fixed element 23 has openings designed to receive opening elements, such as doors 3, a tailgate or hoods, among others. These openings each define, in relation to the fixed vehicle body element, a plane, substantially vertical in the case of the door 3, in which the joint direction is found.

During these assembly operations, the doors and other opening elements 3 are mounted on the fixed element 23 using suitable hinges. However, these opening elements 3 are not yet equipped with permanent closing devices and locks. When the vehicle body is ready to receive an application of paint or a protective coating, the opening elements 3 must be placed in a position close to their closed position, or pseudo-closed position, so as to cover all of the external parts of the vehicle body. These opening elements 3 are maintained separated from the fixed structure in this position with the help of the spacing device 20 as previously described.

Some opening elements 3, for reasons of weight and conformation, have a natural tendency to adopt an open position, and it is therefore appropriate to lock them in the position close to the closed position with the help of a locking device 1 according to the invention.

More precisely, the spacing device 20 is provided to be temporarily fixed on the fixed element 23, in the volume which will be occupied by the lock of the door 3, comprising points for fixing a strike on the fixed element 23 and a corresponding housing provided in the door 3 for said lock. This housing is formed by a cutout 32 made on an internal surface of the opening element 3 and comprises a rim 3b extending perpendicularly to the plane of the opening element and a rim 3a extending parallel to the plane of the opening element 3, i.e. to the wall.

The locking device 1 is placed on the opening element 3. To do this, the second fixing member 8 of the locking device 1 is brought into an open position in which the lip 10 is separated from the fixing plate 2 and the locking hooks 12 are disengaged from said fixing plate. In this position, the smallest distance between the lip 6 and the lip 10 is minimal, and makes it possible to introduce, on one hand, the lip 6 of the first fixing member in a first corresponding orifice arranged in a wall 3a of the fixed element 3 in order to engage with said wall 3a, and on the other hand, the lip 10 of the second fixing member 8 in a second corresponding orifice. The locking device 1 is then fixed in the wall 3a of the fixed element 3 while exerting pressure on the fixing plate 2. In so doing, the second fixing member 8 pivots in the direction of the fixing plate 2 in a closed position in which the locking hooks 12 engage with the fixing plate 2. At the same time, the smallest distance between the lip 6 and the lip 10 increases until the latter engages with the wall 3a of the fixed element 3 and the smallest distance between the two lips 6, 10 is maximal.

Thus locked, the locking device 1 is kept firmly fixed in the wall 3a of the fixed element 3.

As shown in FIG. 2, the locking device 1 and the spacing device 20 are thus positioned on the door 3 and on the vehicle body, respectively, before closing of the door 3. During closing of the door 3, the elastic retaining member 5 abuts against the finger 31 of the spacing device 20. The operator then applies light force to the door 3 to cause the elastic deformation of the retaining member 5 and enable its passage behind the finger 31 of the spacing device 20. The door 3 is then found retained in a close pseudo-closed position in the closed position. One can proceed with the reverse steps to release and open the door 3.

FIGS. 3 and 4 show a view of all of the locking 1 and spacing 20 devices relative to the vehicle body and the door 3.

It should be noted that the spacing device 20 has one end sufficiently separated from its fixing plate 21 to be slightly extended by the finger 31 so as to respond to stresses and be able to cooperate with the locking device 1. A locking device 1 according to the invention may be used with a traditional spacing device, generally much shorter. In this case, the locking device 1 cannot serve as a complementary stop means and it is necessary to attach a third device playing this role. Typically, locking can be done using two locking devices 1 arranged head-to-tail and fixed on the fixed element 23 of the vehicle body and the other on the opening element 3.

It should also be noted that the positions of the locking device 1 and the spacing 20 device may by inversed, the locking device 1 being anchored in a wall of the fixed element of the vehicle body commonly called rabbet, and the spacing device 20 being anchored in a wall of the opening element.

Once the coating or paint has been applied, the spacing 20 and locking 1 devices are removed and the permanent closing devices and locks can be installed.

FIGS. 5 to 7 show a second preferred embodiment of the invention. A locking device 100 is different from a locking device 1 by the fact that it comprises a spherical head 105 in place of the retaining member 5.

This locking device 100 is designed to cooperate with a temporary spacing device 200 which is different from the locking device 20 by the fact that the finger 31 is replaced by a stop means able to cooperate with the spherical head 105 by clipping, said stop means being made in the form of a clamp 201 oriented substantially perpendicularly to the wall 3a of the door 3 when this is in the closed position able to be elastically deformed to engage with the spherical head 105 and thus retain the locking device 100 and, as a result, the door 3. To do this, the clamp 201 comprises two side attachments 202, 203 each having a shoulder 204 able to serve as retaining means for the spherical head 105 and are terminated by a tilted wall 205 connecting the shoulder 204 to the end of the corresponding attachment 202, 203. During closing of the door 3, the spherical head 105 bears on the tilted walls 205 of each attachment 202, 203 of the clamp 201 and forces the separation of the clamp 201 until its passage it enabled behind the shoulders 204 which then keep it in position. The locking device 100 is thus maintained, and with it, the door 3.

It should be noted that as before, the clamp 201 can be attached to a device independent from the spacing device 200 then making it possible to use the locking device 100 alone or in combination with a shorter, traditional spacing device.

Although the invention has been described in connection with particular examples of embodiments, it is obviously in no way limited and includes all technical equivalents of the means described as well as their combinations, if these are within the scope of the invention.

1. Device for temporarily spacing an opening element on a fixed element of a motor vehicle body, comprising, on one hand, means for fixing to a wall of the fixed element or the opening element, and on the other hand, at least one stop element designed to serve as a bearing support for the opening element or the fixed element, characterized in that it comprises at least one stop means designed to cooperate with a corresponding stop means of a connected locking device connected to the opening element or the fixed element, respectively, so as to enable the retaining of said opening element.

2. Spacing device according to claim 1, wherein the stop element is designed so as to be able to be housed between the fixed element and the opening element.

3. Spacing device according to claim 1, wherein the stop means is in the form of a protruding retaining finger.

4. Spacing device according to claim 1, wherein the stop means is present in the form of a clamp.

5. Device for locking an opening element on a fixed element of a motor vehicle body, comprising means for fixing to a wall of the opening element or the fixed element, wherein it comprises at least one stop means designed to cooperate elastically with at least one complementary stop means of a corresponding spacing device according to claim 1 attached to the fixed element or the opening element, respectively.

6. Locking device according to claim 5, wherein it is designed so as to be fixed at the level of a door lining.

7. Locking device according to claim 5, wherein the stop means is able to undergo elastic deformation.

8. Locking device according to claim 5, wherein the stop means is stiff and able to elastically deform the complementary stop means of the spacing device.

9. Locking device according to claim 5, wherein the stop means is made in the form of at least one protruding retaining member.

10. Locking device according to claim 5, wherein the stop means is designed to cooperate with a complementary stop means via a swivel.

11. Assembly for temporary locking of an opening element on a fixed element of a motor vehicle body, characterized in that it comprises at least one device for temporarily spacing an opening element on a fixed element of a motor vehicle body, comprising, on one hand, means for fixing to a wall of the fixed element or the opening element, and on the other hand, at least one stop element designed to serve as a bearing support for the opening element or the fixed element, characterized in that it comprises at least one stop means designed to cooperate with a corresponding stop means of a connected locking device connected to the opening element or the fixed element, respectively, so as to enable the retaining of said opening element, the at least one spacing device cooperating with at least one locking device according to claim 5.
